(19) United States
(12) Patent Application Publication
(10) Pub. No.: US 2022/0410302 A1
(43) Pub. Date: Dec. 29, 2022

(54) METAL DROP EJECTING THREE-DIMENSIONAL (3D) OBJECT PRINTER AND METHOD OF OPERATION FOR FACILITATING RELEASE OF A METAL OBJECT FROM A BUILD PLATFORM

(71) Applicant: Xerox Corporation, Norwalk, CT (US)

(72) Inventors: Jason M. LeFevre, Penfield, NY (US); Paul J. McConville, Webster, NY (US); Douglas K. Herrmann, Webster, NY (US); Chu-Heng Liu, Penfield, NY (US); Seemit Praharaj, Webster, NY (US); Robert R. Reed, West Henrietta, NY (US)

(21) Appl. No.: 17/360,515

(22) Filed: Jun. 28, 2021

(51) Int. Cl. B23K 11/00; B23K 11/36; B33Y 10/00; B33Y 30/00

(52) U.S. Cl. CPC B23K 11/0013; B23K 11/36; B33Y 10/00; B33Y 30/00

(57) ABSTRACT

A three-dimensional (3D) metal object manufacturing apparatus is equipped with a vacuum system and a hold-down plate to secure a metal foil to the hold-down plate during manufacture of a metal object. The melted metal drops ejected by the apparatus to form the object bond to the metal foil to form the base layer of the object. When the vacuum system is deactivated after manufacture of the object is complete, the object and foil are removed from the apparatus intact and the foil not part of the base layer is trimmed from the object.

### TECHNICAL FIELD

This disclosure is directed to three-dimensional (3D) object printers that eject melted metal drops to form objects and, more particularly, to the formation of a base layer of a metal object on a build platform in such printers.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers, while other technologies melt an elastomer and extrude the thermoplastic material into object layers. The printer typically operates one or more ejectors or extruders to form successive layers of plastic or thermoplastic material to construct a three-dimensional printed object with a variety of shapes and structures. After each layer of the three-dimensional printed object is formed, the plastic material is UV cured and hardens to bond the layer to an underlying layer of the three-dimensional printed object. This additive manufacturing method is distinguishable from traditional object-forming techniques, which mostly rely on the removal of material from a work piece by a subtractive process, such as cutting or drilling.

Recently, some 3D object printers have been developed that eject drops of melted metal from one or more ejectors to form 3D objects. These printers have a source of solid metal, such as a roll of wire or pellets, that feeds solid metal into a heated receptacle of a vessel in the printer where the solid metal is melted and the melted metal fills the receptacle. The receptacle is made of non-conductive material around which an electrical wire is wrapped to form a coil. An electrical current is passed through the coil to produce an electromagnetic field that causes the meniscus of the melted metal at a nozzle of the receptacle to separate from the melted metal within the receptacle and be propelled from the nozzle. A build platform is positioned to receive the ejected melted metal drops from the nozzle of the ejector and this platform is moved in a X-Y plane parallel to the plane of the platform by a controller operating actuators. These ejected metal drops form metal layers of an object on the platform and another actuator is operated by the controller to alter the distance between the ejector and the platform to maintain an appropriate distance between the ejector and the most recently printed layer of the metal object being formed. This type of metal drop ejecting printer is also known as a magnetohydrodynamic (MEM) printer.

During the printing process performed with a MHD printer, the first layer of the object must adhere securely to the surface of the build platform. Without this adherence, the base of the object does not remain stable as the size of the object increases. The high temperature of the surface of the build platform can cause the surface of the build platform to become very highly oxidized. This oxidation layer can interfere with the adherence of the object base layer to the build platform and the object may prematurely release from the build platform surface during printing. Additionally, the oxidation layer can cause the base layer of the object to form non-uniformly so the base layer has a porosity that is higher than that required for stable object layer printing.

Oxidation of the build platform surface, however, is not the only issue affecting appropriate adherence of the object to the build platform. A relatively clean build platform surface can result in the base layer of the object bonding too well to the build platform surface. While the manufacture of the object proceeds well since the base of the object is very stable, removal of the object at the end of the process can be very difficult. In some cases, the attachment of the object to the build platform is so secure that removal of the object causes damage to the object, the build platform, or both. Being able to adhere the base layer to the build platform sufficiently to form that layer uniformly and with the appropriate porosity without so securely attaching the object to the build platform that its removal results in damage to the object, the platform, or both would be beneficial.

### SUMMARY

A new method of operating a 3D metal object printer adheres the base layer of a metal object to the build platform sufficiently to form that layer uniformly and with the appropriate porosity without so securely attaching the object to the build platform that its removal results in damage to the object, the platform, or both. The method includes positioning a metal foil between an ejector head configured to eject drops of melted metal and a planar member toward which the ejector head ejects the melted metal drops, and operating the ejector head to eject melted metal drops on the metal foil to form a metal object that bonds to the metal foil.

A new 3D metal object printer adheres the base layer of a metal object to the build platform sufficiently to form that layer uniformly and with the appropriate porosity without so securely attaching the object to the build platform that its removal results in damage to the object, the platform, or both. The new 3D metal object printer includes an ejector head having a vessel with a receptacle within the vessel that is configured to hold melted metal, a planar member, and a metal foil positioned between the ejector head and the planar member to receive the melted metal drops ejected from the ejector head.

### BRIEF DESCRIPTION OF THE DRAWINGS

The foregoing aspects and other features of a method for operating a 3D metal object printer that adheres the base layer of a metal object to the build platform sufficiently to form that layer uniformly and with the appropriate porosity without so securely attaching the object to the build platform that its removal results in damage to the object, the platform, or both and a 3D metal object printer that implements the method are explained in the following description, taken in connection with the accompanying drawings.

FIG. 1 depicts a new 3D metal object printer that adheres the base layer of a metal object to a metal foil layer on a build platform sufficiently to form the base layer uniformly and with the appropriate porosity without so securely attaching the object to the build platform that its removal results in damage to the object, the platform, or both.

FIG. 2 is a schematic diagram of a foil holding vacuum system used to provide a base layer for a metal object to be formed on the build platform in FIG. 1.

FIG. 3A depicts an object formed on the foil shown in FIG. 2 after the foil has been removed from the build platform and FIG. 3B depicts the removal of the object from the foil.

FIG. 4 is a flow diagram for a process that secures the base layer of a metal object to a metal foil layer on a build platform sufficiently to form the base layer uniformly and with the appropriate porosity without so securely attaching the object to the build platform that its removal results in damage to the object, the platform, or both.

FIG. 5 is a schematic diagram of a prior art 3D metal printer that does not include a foil layer and vacuum system for securing the base layer of a metal object.

### DETAILED DESCRIPTION

For a general understanding of the environment for the 3D metal object printer and its operation as disclosed herein as well as the details for the printer and its operation, reference is made to the drawings. In the drawings, like reference numerals designate like elements.

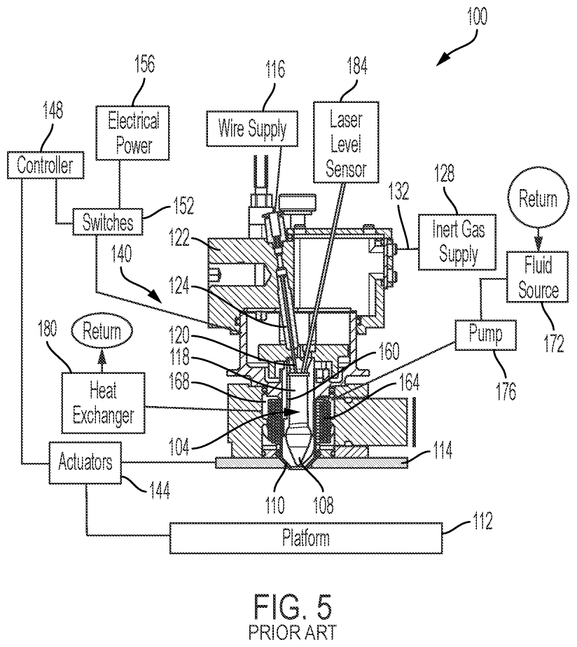

FIG. 5 illustrates an embodiment of a previously known 3D metal object printer 100 that ejects drops of a melted metal to form a metal object directly on a build platform. In the printer of FIG. 5, drops of melted bulk metal are ejected from a receptacle of a removable vessel 104 having a single nozzle 108 and drops from the nozzle form a base layer of an object with swaths applied directly to a build platform 112. As used in this document, the term “removable vessel” means a hollow container having a receptacle configured to hold a liquid or solid substance and the container as a whole is configured for installation and removal in a 3D metal object printer. As used in this document, the term “vessel” means a hollow container having a receptacle configured to hold a liquid or solid substance that may be configured for installation and removal from a 3D object metal printer. As used in this document, the term “bulk metal” means conductive metal available in aggregate form, such as wire of a commonly available gauge, pellets of macro-sized proportions, and metal powder.

With further reference to FIG. 5, a source of bulk metal 116, such as metal wire 120, is fed into a wire guide 124 that extends through the upper housing 122 in the ejector head 140 and melted in the receptacle of the removable vessel 104 to provide melted metal for ejection from the nozzle 108 through an orifice 110 in a baseplate 114 of the ejector head 140. As used in this document, the term “nozzle” means an orifice fluidically connected to a volume within a receptacle of a vessel containing melted metal that is configured for the expulsion of melted metal drops from the receptacle within the vessel. As used in this document, the term “ejector head” means the housing and components of a 3D metal object printer that melt, eject, and regulate the ejection of melted metal drops for the production of metal objects. A melted metal level sensor 184 includes a laser and a reflective sensor. The reflection of the laser off the melted metal level is detected by the reflective sensor, which generates a signal indicative of the distance to the melted metal level. The controller receives this signal and determines the level of the volume of melted metal in the removable vessel 104 so it can be maintained at an appropriate level 118 in the receptacle of the removable vessel. The removable vessel 104 slides into the heater 160 so the inside diameter of the heater contacts the removable vessel and can heat solid metal within the receptacle of the removable vessel to a temperature sufficient to melt the solid metal. As used in this document, the term “solid metal” means a metal as defined by the periodic chart of elements or alloys formed with these metals in solid rather than liquid or gaseous form. The heater is separated from the removable vessel to form a volume between the heater and the removable vessel 104. An inert gas supply 128 provides a pressure regulated source of an inert gas, such as argon, to the ejector head through a gas supply tube 132. The gas flows through the volume between the heater and the removable vessel and exits the ejector head around the nozzle 108 and the orifice 110 in the baseplate 114. This flow of inert gas proximate to the nozzle insulates the ejected drops of melted metal from the ambient air at the baseplate 114 to prevent the formation of metal oxide during the flight of the ejected drops. A gap between the nozzle and the surface on which an ejected metal drop lands is intentionally kept small enough that the inert gas exiting around the nozzle does not dissipate before the drop within this inert gas flow lands.

The ejector head 140 is movably mounted within Z-axis tracks for movement of the ejector head with respect to the platform 112. One or more actuators 144 are operatively connected to the ejector head 140 to move the ejector head along a Z-axis and are operatively connected to the platform 112 to move the platform in an X-Y plane beneath the ejector head 140. The actuators 144 are operated by a controller 148 to maintain an appropriate distance between the orifice 110 in the baseplate 114 of the ejector head 140 and a surface of an object on the platform 112.

Moving the platform 112 in the X-Y plane as drops of molten metal are ejected toward the platform 112 forms a swath of melted metal drops on the object being formed. Controller 148 also operates actuators 144 to adjust the distance between the ejector head 140 and the most recently formed layer on the substrate to facilitate formation of other structures on the object. While the molten metal 3D object printer 100 is depicted in FIG. 5 as being operated in a vertical orientation, other alternative orientations can be employed. Also, while the embodiment shown in FIG. 5 has a platform that moves in an X-Y plane and the ejector head moves along the Z axis, other arrangements are possible. For example, the actuators 144 can be configured to move the ejector head 140 in the X-Y plane and along the Z axis or they can be configured to move the platform 112 in both the X-Y plane and Z-axis.

A controller 148 operates the switches 152. One switch 152 can be selectively operated by the controller to provide electrical power from source 156 to the heater 160, while another switch 152 can be selectively operated by the controller to provide electrical power from another electrical source 156 to the coil 164 for generation of the electrical field that ejects a drop from the nozzle 108. Because the heater 160 generates a great deal of heat at high temperatures, the coil 164 is positioned within a chamber 168 formed by one (circular) or more walls (rectilinear shapes) of the ejector head 140. As used in this document, the term “chamber” means a volume contained within one or more walls within a metal drop ejecting printer in which a heater, a coil, and a removable vessel of a 3D metal object printer are located. The removable vessel 104 and the heater 160 are located within such a chamber. The chamber is fluidically connected to a fluid source 172 through a pump 176 and also fluidically connected to a heat exchanger 180. As used in this document, the term “fluid source” refers to a container of a liquid having properties useful for absorbing heat. The heat exchanger 180 is connected through a return to the fluid source 172. Fluid from the source 172 flows through the chamber to absorb heat from the coil 164 and the fluid carries the absorbed heat through the exchanger 180, where the heat is removed by known methods. The cooled fluid is returned to the fluid source 172 for further use in maintaining the temperature of the coil in an appropriate operational range.

The controller 148 of the 3D metal object printer 100 requires data from external sources to control the printer for metal object manufacture. In general, a three-dimensional model or other digital data model of the object to be formed is stored in a memory operatively connected to the controller 148. The controller can selectively access the digital data model through a server or the like, a remote database in which the digital data model is stored, or a computer-readable medium in which the digital data model is stored. This three-dimensional model or other digital data model is processed by a slicer implemented with the controller to generate machine-ready instructions for execution by the controller 148 in a known manner to operate the components of the printer 100 and form the metal object corresponding to the model. The generation of the machine-ready instructions can include the production of intermediate models, such as when a CAD model of the device is converted into an STL data model, a polygonal mesh, or other intermediate representation, which in turn can be processed to generate machine instructions, such as g-code, for fabrication of the object by the printer. As used in this document, the term “machine-ready instructions” means computer language commands that are executed by a computer, microprocessor, or controller to operate components of a 3D metal object additive manufacturing system to form metal objects on the platform 112. The controller 148 executes the machine-ready instructions to control the ejection of the melted metal drops from the nozzle 108, the positioning of the platform 112, as well as maintaining the distance between the orifice 110 and a surface of the object on the platform 112.

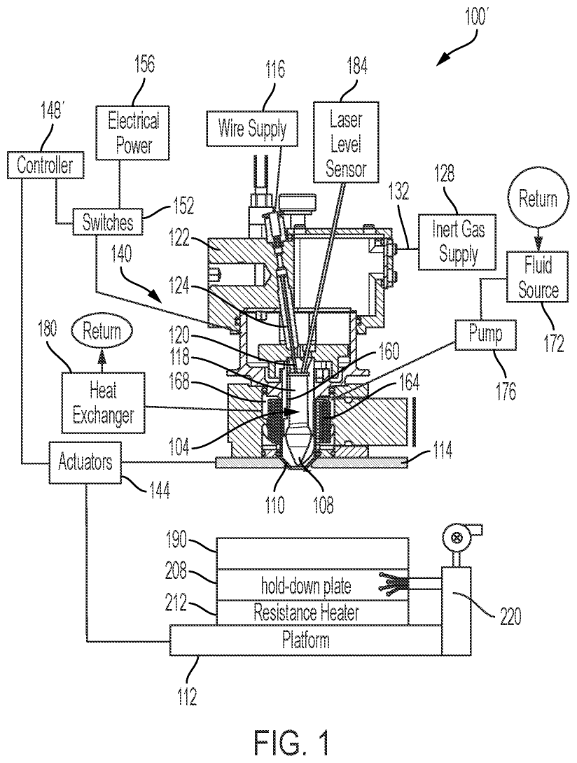

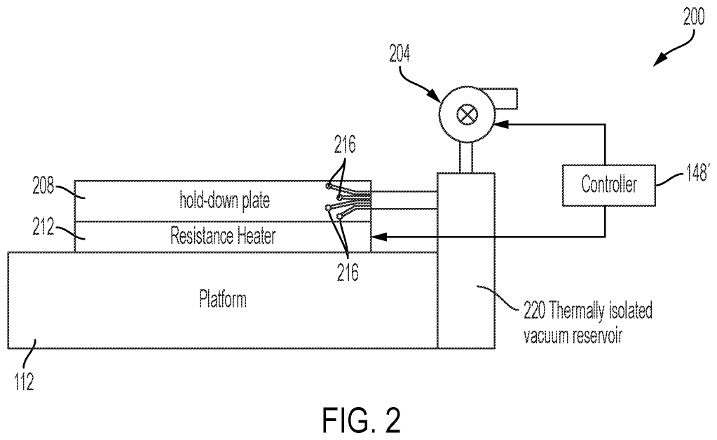

Using like reference numbers for like components and removing some of the components not used to stabilize the object during formation without attaching the object too rigidly to the platform 112, a new 3D metal object printer 100′ is shown in FIG. 1. The printer 100′ includes a sheet of metal foil 190 and a vacuum system 200, described in more detail with reference to FIG. 2, as well as a controller 148′ configured with programmed instructions stored in a non-transitory memory connected to the controller so when the controller 148′ executes the programmed instructions it operates the vacuum system as described below to form a stable foundation for a metal object produced by the system without attaching the object too strongly to the build platform 112.

Vacuum system 200 is shown in more detail in FIG. 2. The vacuum system 200 includes a vacuum 204 that is fluidically connected to the thermally isolated reservoir 220 and the holes 216 in the hold-down plate 208 to secure metal foil 190 to a hold-down plate 208. A heater 212 is interposed between the hold-down plate 208 and the build platform 112 to maintain the hold-down plate 208 and the foil 190 at a temperature conducive for metal object formation. The controller 148′ is operatively connected to the heater 212 to operate the heater selectively and maintain the hold-down plate temperature in a range of about 400° C. to about 600° C. In some embodiments, the heater is an electrical resistance heater, although other implementations of a heater can be used. The hold-down plate 208 is made with a highly thermal conductive material, such as brass. As used in this document, the term “brass” means a metal alloy essentially comprised of copper and zinc. In some embodiments, the surface of the brass hold-down plate is nickel-plated. The reservoir 220 and the conduits connecting the holes 216 in the hold-down plate 208 and the vacuum reservoir 220 are made of high temperature resistant materials to withstand the temperatures in the environment of the printer 100′. The metal foil is made of the same metal as the metal ejected by the ejector head 140 to form the metal object. In those embodiments in which the ejector head ejects melted aluminum drops to form aluminum objects, the aluminum foil has a thickness in the range of about 0.5 mils to about 3 mils, although other thicknesses can be used provided they do not interfere with the vacuum pull on the sheet. As used in this document, the term “metal foil” means a flexible metal planar member. The vacuum is configured to pull a vacuum of about 10″ to about 30″ Hg.

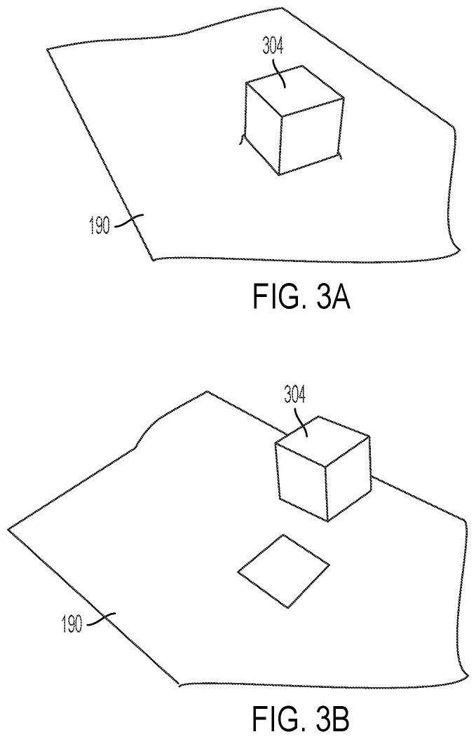

FIG. 3A shows a metal object 304 that has been formed on a metal foil sheet 190 that was held in place by the vacuum system 200. The object 304 and the foil 190 have been removed from the printer 100′ after the vacuum system 200 was deactivated. The portion of the metal foil sheet directly beneath the object 304 has become the base layer of the object. Using a knife or other separating tool, the portion of the foil 190 that did not form part of the object base layer is removed from the object as shown in FIG. 3B. Thus, the object 304 has been removed from the printer 100′ without damaging the object 304, the hold-down plate 208, resistance heater 212, or the build platform 112.

The controller 148′ can be implemented with one or more general or specialized programmable processors that execute programmed instructions. The instructions and data required to perform the programmed functions can be stored in memory associated with the processors or controllers. The processors, their memories, and interface circuitry configure the controllers to perform the operations previously described as well as those described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits. During metal object formation, image data for a structure to be produced are sent to the processor or processors for controller 148′ from either a scanning system or an online or work station connection for processing and generation of the signals that operate the components of the printer 100′ to form an object on the platform 112.

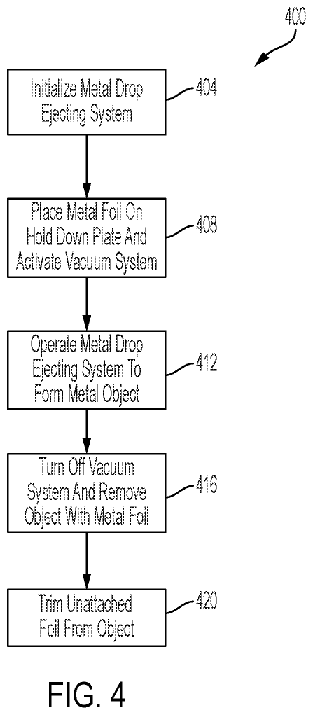

A process for operating the 3D metal object printer 100′ to form a metal object on the surface of a metal foil sheet held by the vacuum system 200 is shown in FIG. 4. In the description of the process, statements that the process is performing some task or function refers to a controller or general purpose processor executing programmed instructions stored in non-transitory computer readable storage media operatively connected to the controller or processor to manipulate data or to operate one or more components in the printer to perform the task or function. The controller 148′ noted above can be such a controller or processor. Alternatively, the controller can be implemented with more than one processor and associated circuitry and components, each of which is configured to form one or more tasks or functions described herein. Additionally, the steps of the method may be performed in any feasible chronological order, regardless of the order shown in the figures or the order in which the processing is described.

FIG. 4 is a flow diagram for a process 400 that operates the vacuum system 200 to hold a sheet of metal foil 190 during formation of a metal object with the printer 100′. The controller 148′ is configured to execute programmed instructions stored in a non-transitory memory operatively connected to the controller to hold a sheet of metal foil during formation of a metal object by the printer. After the printer is initialized (block 404), a sheet of metal foil is placed on the hold-down plate and the vacuum system is activated (block 408). The printer is then operated in a known manner to form the metal object (block 412). Once the manufacture of the object is complete, the vacuum system is deactivated and the object with the metal foil sheet is removed from the printer (block 416). The unattached metal foil is then trimmed from the object (block 420).

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A metal drop ejecting apparatus comprising:
an ejector head having a vessel with a receptacle within the vessel that is configured to hold melted metal;
a planar member; and
a metal foil positioned between the ejector head and the planar member to receive the melted metal drops ejected from the ejector head.

2. The apparatus of claim 1 further comprising:
a plate of thermally conductive material interposed between the metal foil and the planar member.

3. The apparatus of claim 2 wherein the plate of thermally conductive material includes a plurality of holes and the apparatus further comprises:
a vacuum source operatively connected to the plurality of holes in the plate of thermally conductive material to hold the metal foil against the plate of thermally conductive material.

4. The apparatus of claim 3 further comprising:
a controller operatively connected to the ejector head and the vacuum source, the controller being configured to:
operate the vacuum source selectively to hold the metal foil against the plate of thermally conductive material and to release the metal foil from the plate of thermally conductive material; and
operate the ejector head to eject drops of melted metal from the receptacle while the vacuum source is operated to hold the metal foil against the plate of thermally conductive material.

5. The apparatus of claim 4 further comprising:
a heater configured to heat the plate of thermally conductive material; and
the controller is further configured to:
operate the heater to maintain the plate of thermally conductive material in a range of about 400° C. to about 600° C.

6. The apparatus of claim 5 wherein the plate of thermally conductive material is comprised essentially of brass.

7. The apparatus of claim 6 wherein a surface of the brass plate of thermally conductive material includes nickel plating.

8. The apparatus of claim 7 wherein the metal foil is comprised essentially of aluminum.

9. The apparatus of claim 8 wherein the aluminum metal foil has a thickness in a range of about 0.5 mils to about 3.0 mils.

10. The apparatus of claim 9 wherein the heater is an electrical resistance heater.

11. A method of operating a metal drop ejecting apparatus comprising:
positioning a metal foil between an ejector head configured to eject drops of melted metal and a planar member toward which the ejector head ejects the melted metal drops; and
operating the ejector head to eject melted metal drops on the metal foil to form a metal object that bonds to the metal foil.

12. The method of claim 11 further comprising:
interposing a plate of thermally conductive material between the metal foil and the planar member.

13. The method of claim 12 further comprising:
operating a vacuum source operatively connected to a plurality of holes in the plate of thermally conductive material to hold the metal foil against the plate of thermally conductive material.

14. The method of claim 13 further comprising:
operating the vacuum source with a controller to hold the metal foil against the plate of thermally conductive material while the controller operates the ejector head to eject melted metal drops toward the metal foil; and
deactivating the vacuum with the controller to release the metal foil from the plate of thermally conductive material.

15. The method of claim 14 further comprising:
operating a heater configured to heat the plate of thermally conductive material with the controller to maintain the plate of thermally conductive material in a range of about 400° C. to about 600° C.

16. The method of claim 15 wherein the plate of thermally conductive material is comprised essentially of brass.

17. The method of claim 16 wherein a surface of the brass plate of thermally conductive material includes nickel plating.

18. The method of claim 17 wherein the metal foil is comprised essentially of aluminum.

19. The method of claim 18 wherein the aluminum metal foil has a thickness in a range of about 0.5 mils to about 3.0 mils.

20. The method of claim 19, the operation of the heater further comprises:
operating an electrical resistance heater.
